(19) United States
(12) Patent Application Publication
(10) Pub. No.: US 2003/0123892 A1
(43) Pub. Date: Jul. 3, 2003

(54) Image forming apparatus

(76) Inventor: Yukie Kobayashi, Yokohama-shi (JP)

Correspondence Address: FOLEY AND LARDNER, SUITE 500, 3000 K STREET NW, WASHINGTON, DC, 20007, US

(21) Appl. No.: 10/032,616

(22) Filed: Jan. 2, 2002

(51) Int. Cl. G03G 15/20

(52) U.S. Cl. 399/69; 399/327; 399/330

(57) ABSTRACT

An image forming apparatus according to the present invention includes:

a pressing roller for pressing a sheet on which a developer is prepared;

a fixing roller having a hollow portion, which rotates together with said pressing roller with the sheet being sandwiched at a nip portion therebetween, said developer being melted and fixed on the sheet by said fixing roller;

an induction heating coil assembly provided in the hollow portion of said fixing roller, and formed by winding a coil around a long core having a first lateral axis substantially perpendicular to a longitudinal axis of the long core as the center member of the winding in the longitudinal direction, two first opposite surfaces of the core that are opposite along the first lateral axis being non-fixing surfaces where the density of said coil is low, two second opposite surfaces that are opposite along a second lateral axis perpendicular to the longitudinal axis and the first lateral axis being fixing surfaces where the density of said coil is high, and one of the second fixing surfaces being facing the nip portion; and

a cleaning device for removing the developer attached to said fixing roller, provided near said fixing roller not at a position facing the fixing surface side of said induction heating coil but at a position facing said non-fixing surface side.

### FIELD OF THE INVENTION

The present invention relates to an image forming apparatus including a fixing device of induction heating type.

### BACKGROUND OF THE INVENTION

In a fixing device of an image forming apparatus, a toner image is fixed to copying paper by feeding the copying paper (sheet) with unfixed toner (developer) being put thereon through a nip portion formed between a heating roller and a pressing roller, to press the copying paper with the toner being heated and melted. In order to clean the heating roller smeared with toner and paper powder, which are deposited thereon at the time of the fixing operation, a cleaning mechanism is provided to the fixing device.

However, in a conventional fixing device, there is a problem in that the degradation of the cleaning mechanism is advanced due to the overheating of the cleaning mechanism. That is, if the cleaning mechanism is always heated even if the machine is in a ready/idle state when it is not necessary to fix images, the cleaning mechanism is overheated, resulting in the problem that malfunctions of the cleaning mechanism tend to occur. Examples of such a problem are the gelation of oil or oil-dripping if a cleaning roller is used as the cleaning mechanism, and the degradation in durability of the pressing roller if a web is used as the cleaning mechanism. Further, a problem common to both of the above cases is that dirt or dust absorbed by the rollers of the cleaning mechanism are re-deposited to the copying paper.

### SUMMARY OF THE INVENTION

The present invention is proposed in view of the above-described problems, and an object of the present invention is to provide an image forming apparatus including a fixing device of induction heating type, which is capable of preventing the cleaning mechanism from being overheated.

An image forming apparatus according to the present invention includes: a pressing roller for pressing a sheet on which a developer is prepared; a fixing roller having a hollow portion, which rotates together with said pressing roller with the sheet being sandwiched at a nip portion therebetween, said developer being melted and fixed on the sheet by said fixing roller; an induction heating coil assembly provided in the hollow portion of said fixing roller, and formed by winding a coil around a long core having a first lateral axis substantially perpendicular to a longitudinal axis of the long core as the center member of the winding in the longitudinal direction, two first opposite surfaces of the core that are opposite along the first lateral axis being non-fixing surfaces where the density of said coil is low, two second opposite surfaces that are opposite along a second lateral axis perpendicular to the longitudinal axis and the first lateral axis being fixing surfaces where the density of said coil is high, and one of the second fixing surfaces being facing the nip portion; and a cleaning device for removing the developer attached to said fixing roller, provided near said fixing roller not at a position facing the fixing surface side of said induction heating coil but at a position facing said non-fixing surface side.

### BRIEF DESCRIPTION OF THE DRAWINGS

FIG. 1 is a schematic sectional view of a fixing device of an image forming apparatus to which the present invention is applied.

FIG. 2 is a schematic perspective view of the fixing device shown in FIG. 1.

FIG. 3 is a schematic sectional view of a fixing device in which a web-type cleaning mechanism is used.

FIG. 4 is an enlarged sectional view of the web-type cleaning mechanism shown in FIG. 3.

FIG. 5 is a drawing for explaining the temperatures at several points on the surface of the heating roller shown in FIG. 1.

FIG. 6 shows changes in surface temperatures with the lapse of time at the points A and B on the surface of the heating roller shown in FIG. 5.

FIG. 7 is a graph showing the surface temperature distribution in the circumferential direction of the heating roller.

FIG. 8 is a graph showing the relationship between the surface temperature of the heating roller and the occurrence of oil-dripping.

FIG. 9 is a graph showing the relationship between the non-operational time of the heating roller in the ready state and the gelation of oil in relation to the temperature in the non-operational state.

FIG. 10 exemplifies a fixing device in which a cleaning roller is positioned immediately above a heating roller.

### DESCRIPTION OF THE PREFERRED EMBODIMENTS

Hereinafter, an embodiment of the present invention will be described with reference to the accompanying drawings.

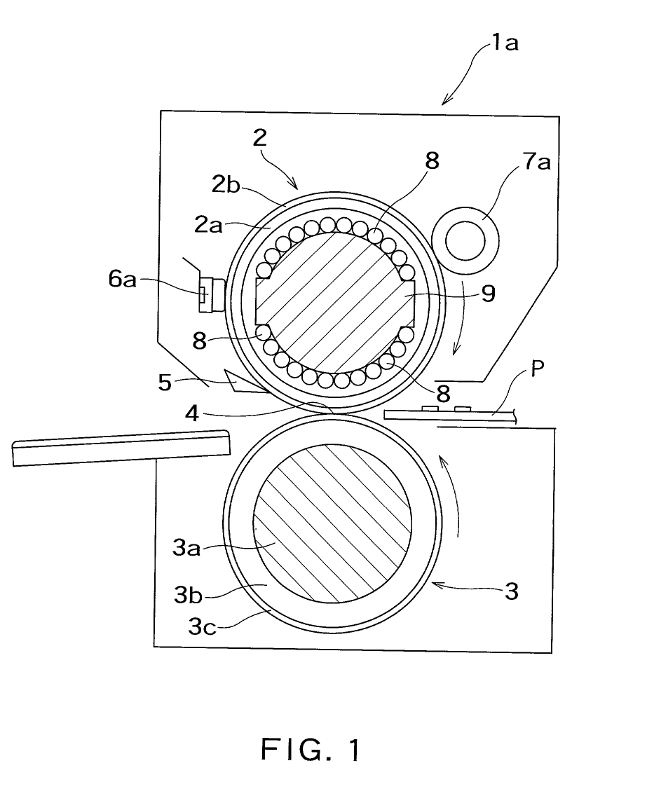

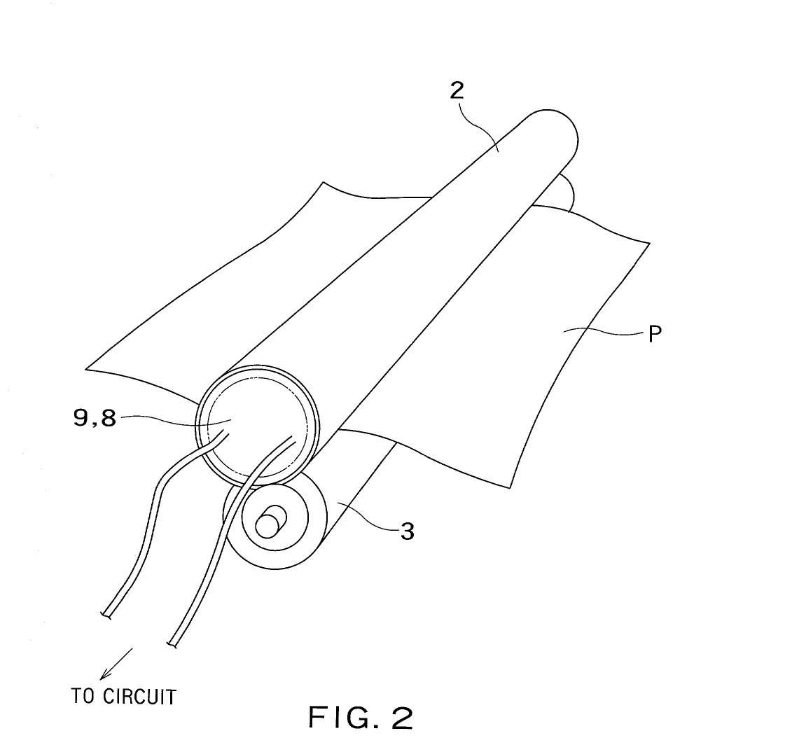

FIG. 1 is a schematic sectional view showing the entire structure and the state of use of a fixing device of an image forming apparatus to which the present invention is applied. FIG. 2 is a schematic perspective view of the fixing device shown in FIG. 1.

A fixing device 1a includes a heating roller (fixing roller) 2 and a pressing roller 3. A sheet is sandwiched between them to be fed, thereby fixing a developer having been prepared on the sheet, such as a toner, to the sheet using heat and pressure. More specifically, the fixing device 1a includes a heating roller 2 (φ40 mm) and a pressing roller 3 (φ40 mm). The pressing roller 3 is pressed against the heating roller 2 by a pressing mechanism (not shown) so as to maintain a constant nip width between the pressing roller 3 and the heating roller 2. The heating roller 2 is rotated by a driving motor (not shown) in the direction of the arrow. Following the rotations of the heating roller 2, the pressing roller 3 rotates in the direction of the arrow shown in the drawing. The heating roller 2 is formed by coating the outer surface of a conducive roller 2a with a releasing layer (adhesion preventing layer) 2b of PFA (Perfluoroalkoxy), PTFE (Polytetra Fluoroethylene) or the like, such as Teflon (brandname), etc. The conductive roller 2a is formed of iron with a wall thickness of 1 mm. Besides iron, stainless steel, aluminum, composite materials formed of stainless steel and aluminum may be used to form the conductive roller 2a. The pressing roller 3 is formed by coating a core 3a with an insulating material 3b such as silicon rubber, fluorine rubber, etc., and by further coating the outer surface of the thus-formed product with a fluorine-containing resin 3c such as Teflon (brand name) etc. The fixing device 1a is constituted such that a toner having been prepared on a sheet of paper P is fixed to the sheet P by passing the sheet P through a pressurized contact portion (nip portion) 4 between the heating roller 2 and the pressing roller 3.

A peeling wedge 5 for peeling off the sheet P from the heating roller 2 is provided in the downstream area of the rotating direction of the heating roller 2, when viewed from the nip portion 4 between the heating roller 2 and the pressing roller 3. In a further downstream area, a thermistor (temperature detecting means) 6a for detecting the surface temperature of the heating roller 2, and a cleaning roller 7a as a cleaning member for removing dust or dirt such as paper powder or toner offset on the heating roller 2, are arranged in this order. The cleaning roller 7a includes a core, an oil-holding layer, i.e., oil-impregnated layer, provided outside the core, and a cleaning layer of a fluorine resin or the like provided outside the oil-holding layer. The cleaning roller 7a is provided to improve the releasing property of the surface of the heating roller 2 by applying oil thereto.

The heating roller 2 is heated by an excitation coil 8 serving as an induction heating device (magnetic field generating means) provided therein. The excitation coil 8 is a Litz wire formed by braiding a plurality of copper wires each having a diameter of 0.5 mm, which are insulated from each other by coating. Since the excitation coil 8 is a Litz wire, it is possible to make the diameter of wire less than the infiltration depth, thereby causing an alternating current to effectively flow through the excitation coil 8. In this embodiment, a Litz wire obtained by braiding 16 coated copper wires each having a diameter of 0.5 mm is used. Further, polyimide, which is heat-resistant, is used as the coating material. The excitation coil 8, i.e., the magnetic field generating means, is formed as an air-core coil, for which no core member, such as ferrite core, iron core, etc., for causing the magnetic flux to focus, is used. Since the excitation coil 8 is an air-core coil, no core member in a complicated shape is required. Accordingly, it is possible to decrease the coil-manufacturing costs. Further, the cost of manufacturing the excitation circuit (inverter circuit) is also reduced. The excitation coil 8 is rotatably supported by a coil-supporting member 9 formed of a heat-resistant resin (in this embodiment, a heat-resistant engineering plastic). The coil-supporting member 9 is positioned relative to a portion of the chassis (not shown) supporting the heating roller 2.

Although the cleaning roller 7a is used as the cleaning member of the heating roller 2, a web-type cleaning mechanism may be used, which will be described below.

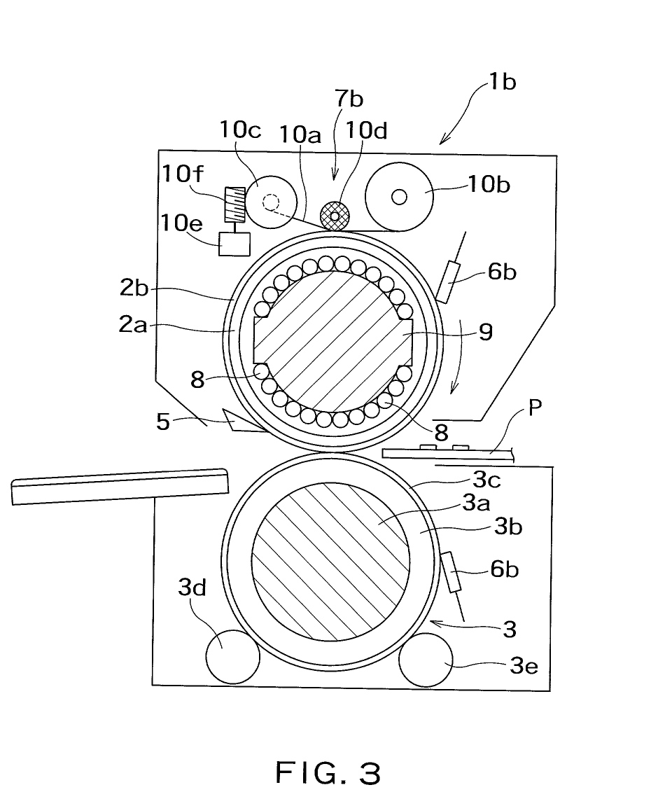

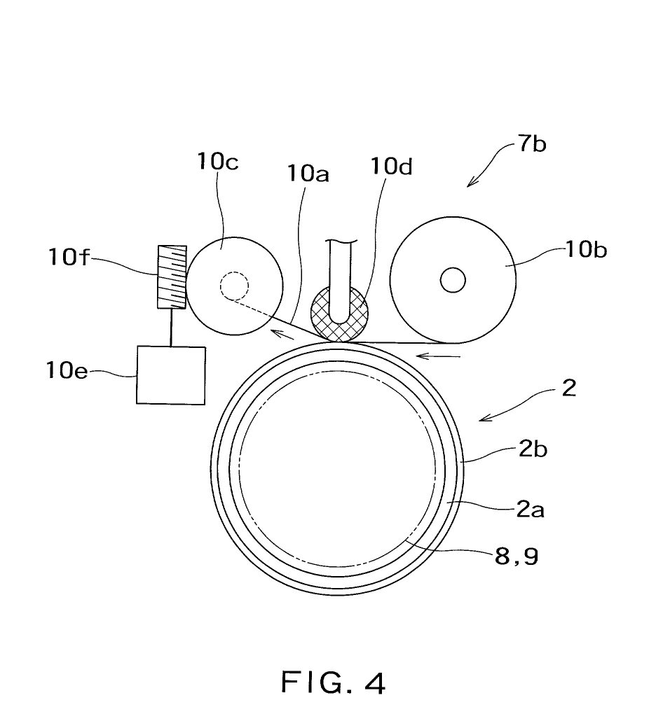

FIG. 3 is a schematic sectional view showing the entire structure and the state of use of the fixing device 1b using a web-type cleaning mechanism as the cleaning member. FIG. 4 is an enlarged sectional view of the main part of the web-type cleaning mechanism shown in FIG. 3. As can be understood from FIGS. 1 and 3, a fixing device 1b of FIG. 3 differs from the fixing device 1a of FIG. 1 in that the web-type cleaning mechanism is used as the cleaning member, that two thermistors 6b are provided to the heating roller 2 and the pressing roller 3, and that the pressing roller 3 is provided with a cleaning roller 3d and an oil roller 3e.

The structure and the operation of the web-type cleaning mechanism will be briefly described with reference to FIGS. 3 and 4.

As can be understood from FIGS. 3 and 4, as the cleaning operation advances, a web 10a wounded around a web roller 10b is sequentially taken up by a web-reeling device 10c. The web 10a is pressed down by a pressing roller 10d as a pressing member so as to contact the heating roller 2. The web-reeling device 10c is driven by a worm gear 10f connected to a driving motor 10e. In FIG. 4, the coil wound around the core provided inside the heating roller 2 is not shown.

When the web-reeling device 10c is driven by the driving motor 10e, the web 10a, being pressed against the heating roller 2, is taken up from the web roller 10b to the web-reeling device 10c. That is, foreign materials attached to the surface of the heating roller 2 are peeled off by the web 10a, thereby cleaning up the heating roller 2.

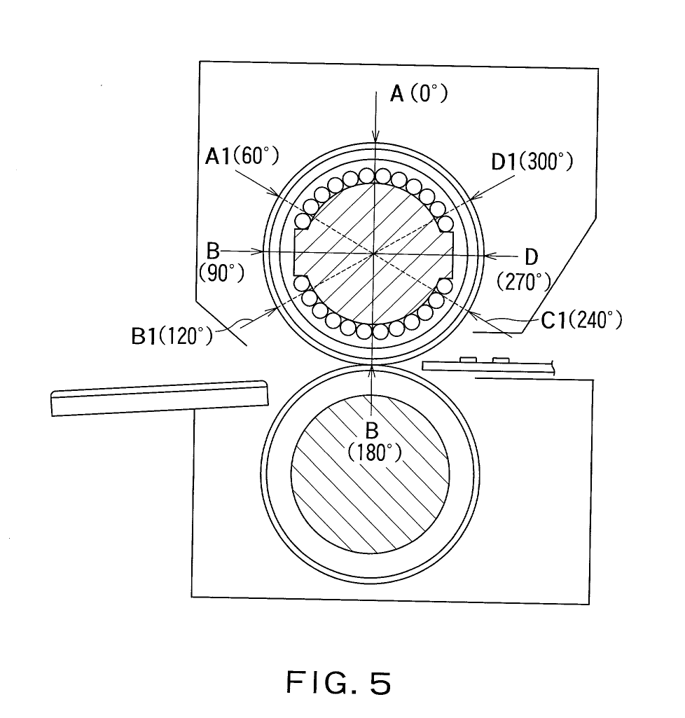

As shown in FIGS. 1 and 5, the cleaning roller 7a is provided at the position D1 in this embodiment. This will be described in detail below.

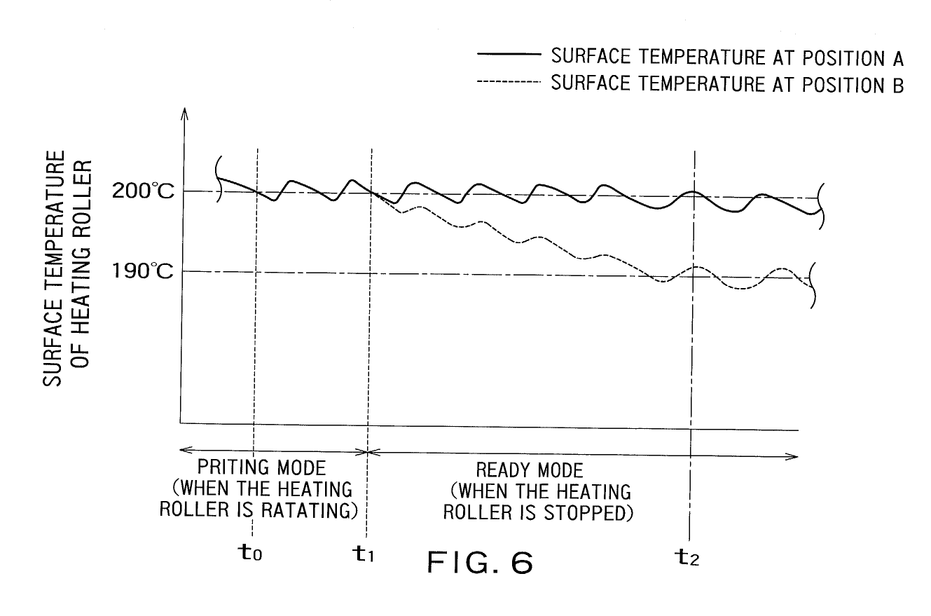

FIG. 6 shows the changes in surface temperature with the lapse of time at the positions A and B (see FIG. 5) of the heating roller 2 in the printing mode (when the heating roller is rotating) and in the ready mode (i.e., in the copy standby mode, when the heating roller is stopped).

As can be understood from FIG. 6, when the heating roller is rotating, i.e., from time t0 to time t1, the surface temperatures of the heating roller 2 at the positions A and B are the same, i.e., 200° C. After time t1, although the surface temperature at the position A of the heating roller 2 continues to be 200° C., the surface temperature at the position B of the heating roller 2 gradually decreases. For example, at time t2, the surface temperature of the position B of the heating roller 2 is 190° C. That is, when the heating roller is stopped, the difference in temperature between the positions A and B of the heating roller 2 is 10° C. at time t2, for example.

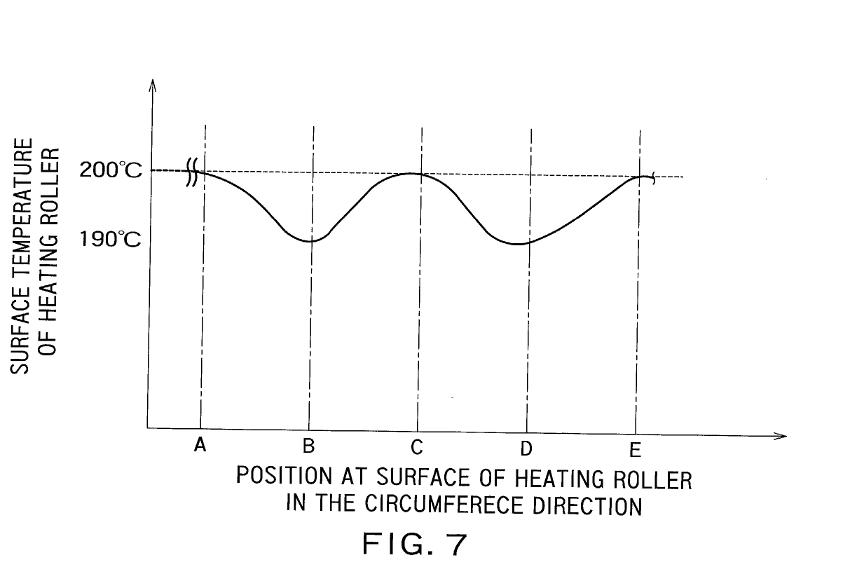

FIG. 7 shows the surface temperature distribution in the circumference direction of the heating roller 2 at time t2.

As can be understood from FIG. 7, at time t2, the surface temperature of the position C continues to be 200° C. as in the case of the position A. However, as in the case of the position B, the surface temperature of the position D gradually decreases to 190° C. This differences in surface temperature in the circumference direction of the heating roller 2 with the lapse of time in the ready mode occurs in that when the induction heating is performed on the heating roller 2, the magnetic flux generated at the excitation coil 8 acts differently on several positions of the heating roller 2 in the circumferential direction.

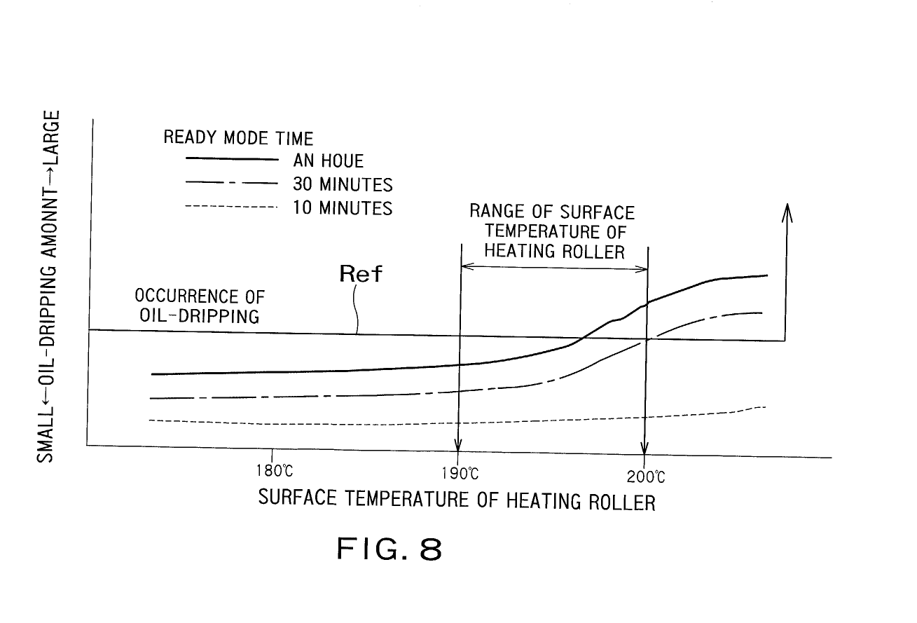

FIG. 8 is a graph made based on the results of an experiment conducted by the present inventor. That is, FIG. 8 is a graph showing the relationship between the surface temperature and the occurrence of oil-dripping, proven by the experiment. More specifically, FIG. 8 shows the relationship between the surface temperature of the heating roller and the occurrence of oil-dripping in three cases, i.e., when the heating roller is not operated and left in the ready mode for 10 minutes, 30 minutes, and an hour. Since the oil-dripping amount is leveled off when the heating roller is left in the ready mode for more than an hour, the maximum time measured was an hour. In the figure, the horizontal axis is the surface temperature of the heating roller, and the longitudinal axis is the amount of oil-dripping. The reference line Ref in the figure indicates the occurrence of oil-dripping. The range of the surface temperature of the heating roller 2 is from 190° C. to 200° C. The present inventor has obtained the following results from the experiment concerning FIG. 8.

Specifically, the higher the surface temperature of a portion of the heating roller 2 at which the cleaning roller 7a is located is, the more easily the oil-dripping occurs. For example, if the cleaning roller 7a is located at the portion of the heating roller 2 where the surface temperature is about 200° C., when the heating roller 2 is not operated for about an hour, the oil-dripping occurs. If the cleaning roller 7a is located at the portion of the heating roller 2 where the surface temperature is about 190° C., no oil-dripping occurs even if the heating roller 2 is left idle for about an hour. From the above results, it is understood that preferably the cleaning roller 7a should be located at a portion of the heating roller 2 where the surface temperature is as low as possible. The present invention was made based on the above-described results of the unique experiment carried out by the present inventor.

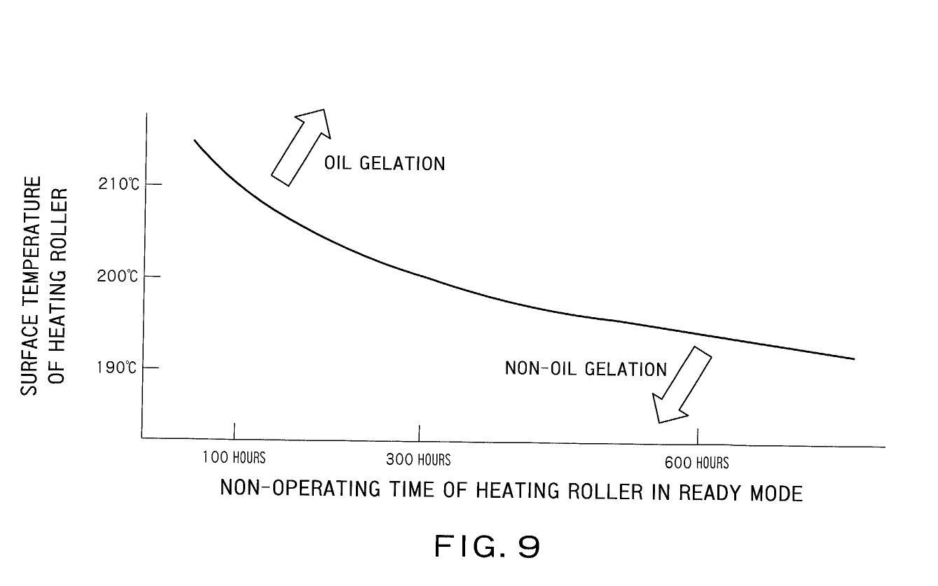

FIG. 9 is a graph made based on the results of another experiment conducted by the present inventor. That is, FIG. 9 is a graph showing the relationship between non-operating time of the heating roller 2 in the ready mode and oil gelation relative to the surface temperature (non-operational temperature) of the heating roller 2, proven by the experiment. A silicon oil with a viscosity of 10,000 cs was used in this experiment. The present inventor has obtained the following results from the experiment concerning FIG. 9.

That is, from FIG. 9, it is understood that the higher the surface temperature of the portion of the heating roller 2 at which the cleaning roller 7a is located is, the more easily the gelation of oil occurs. For example, even if the cleaning roller 7a is left idle for 600 hours at the portion of the heating roller 2 where the surface temperature is 190° C., no gelation of oil occurs. However, if the cleaning roller 7a is left idle for 600 hours at the portion where the surface temperature is 200° C., the gelation of oil occurs. From the above result, it is understood that preferably the cleaning roller 7a should be located at a portion of the heating roller 2 where the surface temperature is as low as possible. As can be understood from the above result, the present invention was made based on the above-described results of the unique experiment carried out by the present inventor.

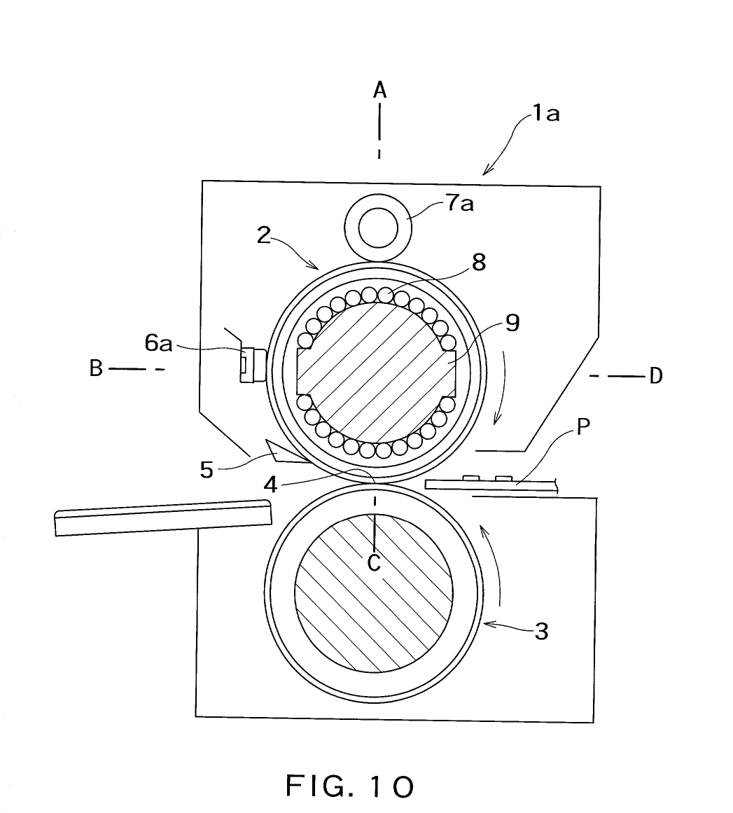

As can be understood from the above results, if the cleaning roller 7a is located near a place between the position D1 and the position A1, or between the position B1 to the position C1 (see FIG. 5), which are close to the heat-generating portions of the excitation coil 8 of the heating roller 2 having the temperature distribution as shown in FIG. 7, the degradation of the cleaning roller 7a is advanced due to overheating. That is, if the cleaning roller 7a is located at the position A as shown in FIG. 10, the cleaning roller 7a is always heated at a high temperature even in the ready mode, when it is not necessary to fix images. As a result, the degradation of the cleaning roller 7a is advanced due to overheating.

In this embodiment, the cleaning roller 7a is located between the position C1 and the position D1 (see FIG. 5), i.e., within the angle range of from 240° to 270° when viewing the position A as the base point 0°. That is, as can be understood from FIG. 7, the cleaning roller 7a is located at the portion of the heating roller 2 where the surface temperature is relatively low when in the ready mode. Accordingly, it is possible to prevent the cleaning roller 7a from being continuously heated at a high temperature in the ready mode. As is clear from FIG. 7, the cleaning roller 7a may be located between the position A1 and the position B1, i.e., within the angle range of from 60° to 120° when viewing the position A as the base point 0°.

Thus, according to this embodiment, since the cleaning roller 7a is located between the position C1 and the position D1 or between the position A1 and the position B1 where the surface temperature of the heating roller 2 is relatively low in the ready mode, it is possible to reduce the thermal burden imposed on the cleaning roller 7a in the ready mode. That is, it is possible to effectively prevent the degradation of the cleaning roller 7a caused by overheating. For example, if a cleaning roller is used as the cleaning member 7, it is possible to prevent the gelation of oil or the dripping of oil. If a web is used as the cleaning member 7, it is possible to prevent the degradation of the pressing roller due to the deterioration of durability. Both of the above cases have the common effect that it is possible to prevent the defect by which dust or dirt absorbed by the cleaning roller 7a is re-deposited to copying paper.

As described above, according to the present invention, the degradation of the cleaning device due to overheating can be prevented since the cleaning device is located on the portion of the fixing roller where the coil density is low.

What is claimed is:

1. An image forming apparatus comprising:
a pressing roller for pressing a sheet on which a developer is prepared;
a fixing roller having a hollow portion, which rotates together with said pressing roller with the sheet being sandwiched at a nip portion therebetween, said developer being melted and fixed on the sheet by said fixing roller;
an induction heating coil assembly provided in the hollow portion of said fixing roller, and formed by winding a coil around a long core having a first lateral axis substantially perpendicular to a longitudinal axis of the long core as the center member of the winding in the longitudinal direction, two first opposite surfaces of the core that are opposite along the first lateral axis being non-fixing surfaces where the density of said coil is low, two second opposite surfaces that are opposite along a second lateral axis perpendicular to the longitudinal axis and the first lateral axis being fixing surfaces where the density of said coil is high, and one of the second fixing surfaces being facing the nip portion; and
a cleaning device for removing the developer attached to said fixing roller, provided near said fixing roller not at a position facing the fixing surface side of said induction heating coil but at a position facing said non-fixing surface side.

2. The image forming device apparatus according to claim 1, wherein said cleaning device is provided in areas on the circumference of said fixing drum, said areas being opposite to each other, each area having the first lateral axis as a center line and covering an angle range of 60° of the circumference from the center of said fixing drum.

3. The image forming apparatus according to claim 1, wherein said cleaning device is a cleaning roller having, at its periphery surface, a cleaning layer impregnated with cleaning oil.

4. The image forming apparatus according to claim 3, wherein the oil is a silicon oil.

5. The image forming apparatus according to claim 1, wherein said cleaning device is a web-type cleaning mechanism having a web impregnated with oil.

6. The image forming apparatus according to claim 5, wherein the oil is a silicon oil.

7. The image forming apparatus according to claim 3, wherein said fixing roller is formed by coating a periphery surface of a conductive roller with a releasing layer for preventing adhesion of dust.

8. The image forming apparatus according to claim 5, wherein said fixing roller is formed by coating an outer surface of a conductive roller with a releasing layer for preventing adhesion of dust.

9. The image forming apparatus according to claim 7, wherein said releasing layer is formed of a fluorine-containing resin.

10. The image forming apparatus according to claim 8, wherein said releasing layer is formed of a fluorine-containing resin.

11. The image forming apparatus according to claim 3, wherein said fixing roller includes a temperature detector, and the surface temperature of said fixing roller is maintained at a predetermined value by a feedback control performed based on an output of said temperature detector.

12. The image forming apparatus according to claim 5, wherein said fixing roller includes a temperature detector, and the surface temperature of said fixing roller is maintained at a predetermined value by a feedback control performed based on an output of said temperature detector.

13. The image forming apparatus according to claim 11, wherein said temperature detector is a thermistor.

14. The image forming apparatus according to claim 12, wherein said temperature detector is a thermistor.

15. The image forming apparatus according to claim 1, wherein said induction heating coil is an air-core coil.

16. The image forming apparatus according to claim 2, wherein said induction heating coil is an air-core coil.
